(19) United States
(12) Patent Application Publication
(10) Pub. No.: US 2005/0050458 A1
(43) Pub. Date: Mar. 3, 2005

(54) HTML page generator system and method

(76) Inventors: Ali Jani, Fairfax, VA (US); Harsha Sarjapur, Centreville, VA (US)

Correspondence Address: Timothy W. Lohse;GRAY CARY WARE & FREIDENRICH LLP, 2000 University Avenue, East Palo Alto, CA, 94303, US

(21) Appl. No.: 10/847,801

(22) Filed: May 17, 2004

Related U.S. Application Data
(60) Provisional application No. 60/499,046, filed on Aug. 29, 2003.

(51) Int. Cl. G06F 9/46

(52) U.S. Cl. 715/513

(57) ABSTRACT

The HTML page generator can be used by any business software application User. Pre-defined HTML Templates with proprietary iTags are installed along with the product on the client system. The HTML page generator replaces these iTags with dynamic data while creating the static HTML pages. The HTML pages will contain META tags for keywords and description using the product information from the database. These static HTML pages can then be submitted to search engines in order to increase traffic to an online shop. The search engines record the information given, thereby ranking, and exposing the site to millions who search the World Wide Web.

### PRIORITY CLAIM

This application claims priority under 35 USC 119 to U.S. Provisional Patent Application Ser. No. 60/499,046, filed on Aug. 29, 2003 and entitled “HTML Page Generator System and Method” which is incorporated herein by reference.

### FIELD OF THE INVENTION

The invention relates to a static hypertext mark-up language (“HTML”) page generating system and more particularly to a method that interacts with a database to obtain the product information and the settings that need to be embedded into the HTML page.

### BACKGROUND OF THE INVENTION

In a typical ASP (Active Server Pages) driven World Wide Web (“Web”) site, all the information is driven through the database and nothing exists in those ASP pages. A dynamic Web page is a template that displays specific information in response to queries. Most of the Web page content comes from the database connected to the Web site. These sites are easy for webmasters to update, such as new/different product offerings or prices change, as they just need to edit the database instead of hundreds of individual Web pages. However, many spiders/crawlers of search engines prefer not to search dynamic Web pages to avoid the constraints involved in search optimization. As the pages generated by e-commerce applications are dynamic in nature, it is desirable to generate static HTML Web pages for an online shop. In other words, the limitation of the known Web browsers and Web Servers is that they are designed to access only HTML documents. Furthermore, typical browsers do not have the facility to cause a Web Server to retrieve and return a non-HTML document. This inhibits a User from accessing non-HTML objects, documents or databases from Web browsers.

Thus, it is desirable to provide a PageBoost system (HTML generator system and method) that overcomes these limitation of present systems and it is to this end the present invention is directed.

### SUMMARY OF THE INVENTION

An HTML page generating system is provided that generates HTML pages from databases such as Everest Advanced Edition (“Everest”). An exemplary implementation of the HTML page generating system is the “PageBoost” module that is part of the Everest business software application developed by iCode, Inc. (“iCode”). A method for generating HTML pages is provided that interacts with a database of a business software application and obtains product information and the settings that need to be embedded into the HTML page.

In a preferred embodiment of the invention, the HTML page generation system is exemplified by the PageBoost module that is an application within the Everest system, which is an e-commerce solution developed by iCode. However, the HTML page generation system may be used with other business software applications and similar e-commerce products where it is desirable to generate an HTML page from a business database. The HTML page generation system allows the User to create static HTML pages with META tags for keywords and descriptions. The User can submit these static HTML pages to search engines in order to increase traffic to the User's online shop. The search engines record the information given by the User, thereby ranking and exposing the User's site to millions who search the Web. The HTML page generation system produces online shopping catalogs, ordinary catalogs, price lists and database contents for the Internet. The program is designed to enable anyone with basic computer knowledge to maintain and update catalogs.

The pages that are generated using the HTML page generation system will also contain title and other contents for every Web-enabled item, item alias and item category. The tool also helps to schedule the creation of these HTML pages periodically to provide for any updates/modifications to the items/categories/item aliases at the back end. In essence, without the HTML page generator, the User does not have the opportunity to attract visitors to its Web site through search engines.

When the HTML page generation system is incorporated into the Everest product developed by iCode, the HTML page generator comes with pre-defined HTML Templates similar to the ASP Templates in the Everest E-commerce feature. The difference being the ASP Templates and the HTML Templates is that the HTML Templates contain iTags which are used to populate the HTML page with the dynamic content from a database. There are two different Templates used by the HTML page generator—one for the index/categories page and one for the item/Item Alias Page.

In accordance with the invention, the HTML page generator is installed on the server with the files required to generate the HTML pages. The generated HTML pages need to be hosted on the Web Server along with the e-commerce dynamic pages so that the User is seamlessly transferred from the static page to the dynamic page by the HTML page generator and taken through the e-commerce shopping process.

In accordance with the invention, an HTML page generating system for use with online product catalogs and shopping carts is provided. The HTML page generation system comprises computer software having a set of instructions to generate HTML pages using the HTML Templates having iTags embedded therein corresponding to the dynamic Templates in the e-commerce software. The page generator system enables the replacement of the iTags in the HTML Templates with the product information in the database. The system may provide one template each for index/Category Pages and for item/Item Alias Pages.

In accordance with another aspect of the invention, an HTML page generating system for use with online product catalogs and shopping carts is provided. The system comprises a set of HTML Templates with iTags, one for index/Category Pages and the other for item/Item Alias Pages, means for contacting and obtaining the product information and other settings from the Database Server, means for replacing the iTags with product information from the database and means for producing the HTML page with META tags for keywords and description and with product information being generated for categories/items/item aliases.

In accordance with another aspect of the invention, a method of generating HTML pages for online product catalogs and shopping carts by integrating seamlessly with the database, which can be submitted to search engines is provided. In accordance with yet another aspect of the invention, a method of generating HTML pages for online product catalogs and shopping carts is provided. In the method, a set of HTML Templates with iTags are created in which there is one template for each index/Category Page and one for item/Item Alias Pages. Next, product information and other settings are obtained from the Database Server and the iTags are replaced with the product information so obtained. Next, the HTML page with META tags for keywords and description and with product information for categories/items/item aliases is generated.

### BRIEF DESCRIPTION OF THE DRAWINGS

These and other aspects of the invention will become apparent from the following description read in conjunction with the accompanying drawings:

FIG. 1 is a system that incorporates the HTML page generator system in accordance with the invention;

FIG. 2 illustrates the prerequisite process of the User buying and installing Everest;

FIG. 3 illustrates the User buying and installing the HTML page generator;

FIG. 4A illustrates the process followed by the HTML page generator to create the HTML files in accordance with the invention;

FIG. 4B is an example of a computer system implementation of the HTML page generation system in accordance with the invention;

FIG. 5 illustrates an example of a User interface for instructions/settings for the User;

FIGS. 6A and 6B illustrate an example of a template for an index page for an item and a template for a Category Page, respectively;

FIGS. 6C and 6D illustrate an example of an ASP Category Page and a corresponding HTML Category Page that are generated for an e-commerce site using the HTML page generator system in accordance with the invention;

FIGS. 6E and 6F illustrate an example of an ASP Item Page and a corresponding HTML Item Page that are generated for an e-commerce site using the HTML page generator system in accordance with the invention;

FIGS. 7A-C are examples of a first and second Category Page META tag User interfaces and a listing of the source of the META tags, respectively;

FIG. 8A-C are examples of a first and second Item Page META tag User interfaces and a source of the META tags, respectively; and

FIG. 9 illustrates a User interface that permits the User of the HTML page generator system to select the META database fields for a particular HTML page to be generated by the system.

### DETAILED DESCRIPTION OF A PREFERRED EMBODIMENT

The invention is particularly applicable to an HTML page generation system and method that is incorporated into an Everest business software application developed by iCode and it is in this context that the invention will be described. It will be appreciated, however, that the HTML page generation system and method in accordance with the invention has greater utility, such as to other system in which it may be desirable to have an HTML page generation system with the features described herein. For purposes of the following description, certain specific terms here will be defined:

Everest is a business software application computer program into which the HTML page generator system and method may be incorporated. Everest contains different modules for inventory, invoicing, purchasing, and accounting, which the User uses to maintain its data. This computer program is used as an example of a system into which the HTML page generating process and system may be incorporated.

Everest E-commerce is a module of Everest system that allows the User to create an online shop for its products. This module is also used as an example of a system into which the HTML page generating process and system may be incorporated.

User is the merchant who buys Everest and other integrated products including the HTML page generation system.

Application Server is the well known computer system on which the Everest program is installed.

Database Server is the system where the database, such as Microsoft SQL, for Everest resides. The Database Server may reside on the same physical computer system, such as a server, as the Application Server.

Web Server is where the Everest E-commerce pages are published. The Web Server may also reside of the same physical computer system, such as a server, as the Application Server or the Database Server.

HTML refers to Hyper Text Markup Language, which is the world wide standard for static Web pages.

Templates are included in Everest E-commerce. There are one or more Templates (fifteen in a preferred embodiment) in the e-commerce module and the User has the option of using any of those for its dynamic Web site. All these 15 Templates are also available in the HTML page generator so that the User can choose the same template for the HTML pages also.

Index Page is the home page of the e-commerce Web site.

Category Page is the page where the items belonging to a particular category are displayed.

Item Page is the page where the item description or the item details are displayed.

Item Alias Page is similar to the Item Page where the description, price and other details are different for the alias to the item.

META Keyword Tag—A META Keyword Tag lists all the keywords for which the User would like search engines to rank its site. Although not all search engines support this tag, META Keyword Tags should be used for the search engines that support these tags. META tags are hidden in a document's source, invisible to the reader. Some search engines, however, are able to incorporate the content of META tags into their algorithms. No engines penalize sites that use META tags properly, so it is recommended to include them.

An example of a META Keyword Tag:

<HTML>
<HEAD>
<META name=“keywords” content=“Your site's keywords here”>
</HEAD>
</HTML>

META Description Tag—A META Description Tag is similar to the META Keyword Tag, the difference being that it is a one/two line brief description in the form of a correct English sentence.

iTags are proprietary HTML tags, which are replaced with information from the database while generating the HTML page in accordance with the invention.

For example, “$Categories$” is an iTag that creates main navigation links allowing the shopper to navigate different categories of a shopping cart. Based on the settings to display the number of categories per page the HTML page will be generated with either static or dynamic links specified during generating.

Web Crawler/Spider—A Web crawler (also known as a Web spider) is a well known program which browses the Web in a methodical, automated manner. Web crawlers typically keep a copy of all the visited pages for later processing, for example by a search engine.

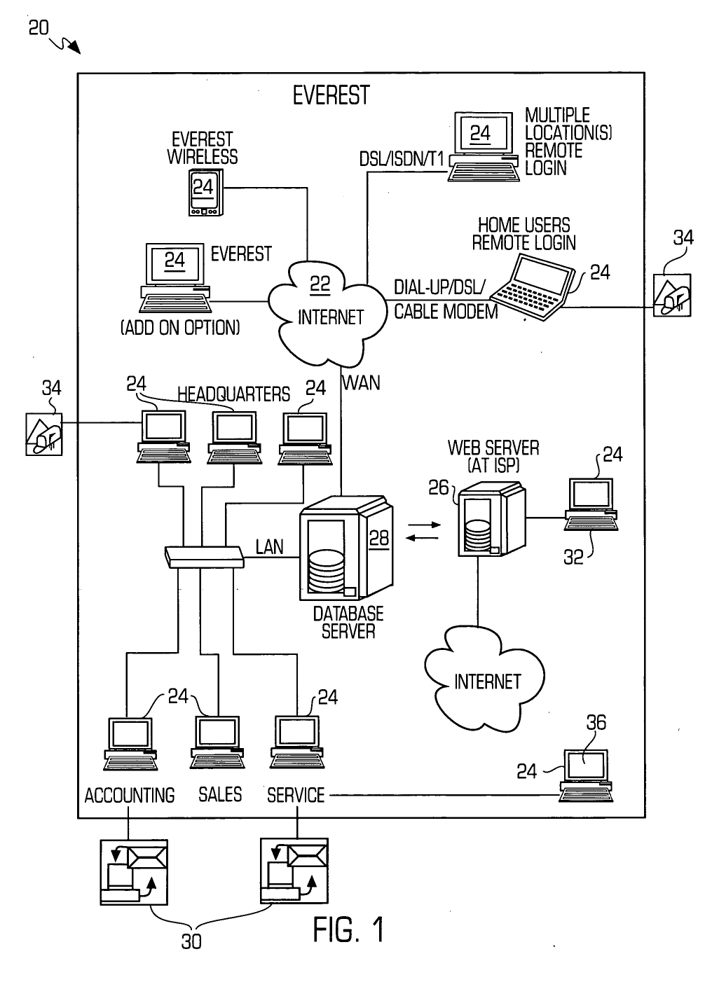

A system that may incorporate the HTML page generation system in accordance with the invention will now be described. FIG. 1 is an overall block diagram of a business software application system 20 that incorporates a mail management system in accordance with the invention. In the preferred embodiment, the system 20 is the Everest software application that is being executed on a computer network/system as shown. However, the system may also be any other business software application. The system 20 is connected together by a computer network 22, such as the Internet as shown, the World Wide Web or any other computer network, wherein a plurality of different computing resources 24 are connected together. Each computing resource 24 is a computer system that is capable of executing computer software code to implement the business software application and the mail management system, such as the laptop, wireless device, and desktop systems as shown. Each computing resource has the well known components of a computer system, such as one or more processors, memory, such as SRAM or DRAM or flash memory, a persistent storage device, such as a hard disk drive, optical disk drive, or tape drive, and optional input/output devices, such as keyboards, mice, LCDs, CRTs, printers and the like. The system is not limited to any particular type of computing resource, however, as the business software application may be implemented using various computer systems. The computing resources of the system 20 are connected together by a wide area network (WAN) and a local area network (LAN) as shown. As shown, the system 20 also may include a Web Server 26 that permits Web access to the system by the computer resources 24. The system 20 may further include a Database Server 28 which is connected to the various computing resources and acts as a data repository for the system and its parts. The elements of the Database Server 28 are well known and not described herein. In a preferred embodiment, a Microsoft SQL server may be used, but the Database Server may also be implemented using an Oracle or Siebel product. The system shown in FIG. 1 may further include a well known Application Server and a well known Web Server (both not shown) that may reside on the same physical computer system as the Database Server or may be on separate computer systems.

The system may further include a mail management system 30 that is integrated within a Microsoft Outlook e-mail client. The mail management system allows employees to be more informed on all e-mail interactions between customers and anyone in an organization and grants a User access to all such e-mails stored within Everest. In a preferred embodiment, the mail management system is one or more pieces of software code, executing on a computing resource 24, that perform the various functions of the mail management system. The system may further include a PageBoost system 32 that is a search engine solution, which integrates with Everest by generating optimized HTML pages ready to be submitted to various search engines for higher page ranking, traffic hits and seamlessly integrates with Everest solution. In a preferred embodiment, the PageBoost system is one or more pieces of software code, executing on a computing resource 24, that perform various functions. The PageBoost system (HTML page generation system) will be described in more detail below. The system may further include an e-mail client system 34 that sends and receives e-mail directly from Everest. Employees are more informed because they have access to all e-mail sent between customers, vendors and anyone in an organization, wherein the Everest E-Mail client replaces any e-mail client such as Outlook and integrates with Everest. In a preferred embodiment, the e-mail client system is one or more pieces of software code, executing on a computing resource 24, that perform various functions. The system may further include a PayBridge system 36 that bridges between different payment processors for processing credit card transactions with different payment processors and integrates with Everest allowing customers to use their own payment processors. In a preferred embodiment, the PayBridge system is one or more pieces of software code, executing on a computing resource 24, that perform various functions. The HTML page generation process and system (PageBoost) is described in more detail as follows.

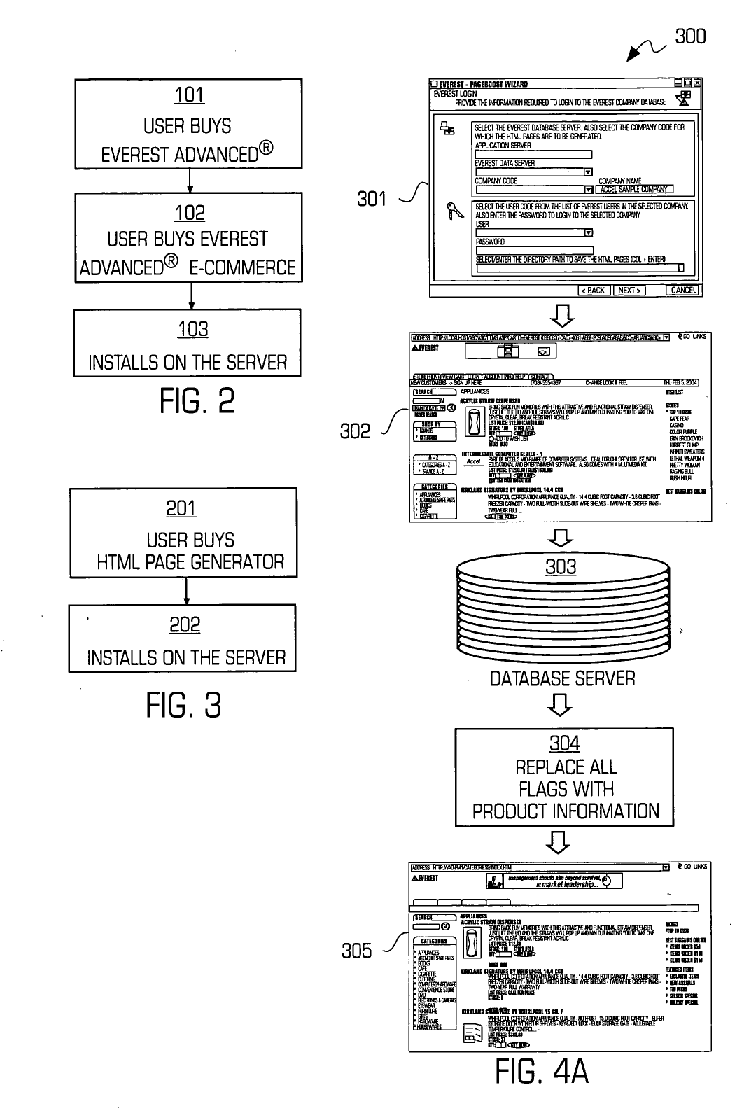

In FIG. 2, the pre-requisites for the HTML page generator are purchased and installed on a server when used in combination with the exemplary Everest business software application. In other examples and implementations, the HTML page generation system does not have any pre-requisites except Everest. For example, the HTML page generation system may be incorporated into another e-commerce solution. For the Everest example, a User buys Everest in step 101 that includes the e-commerce module as shown in step 102. These have to be installed on a server (see step 103), which is referred to as the Application Server. The installation also requires a Database Server. The Everest system preferably is installed on a Web Server. FIG. 3 illustrates the next step for the User, which is to purchase (the HTML page generator preferably may be part of the purchase of the Everest software) and install the HTML page generator in steps 201 and 202 so that the HTML page generator has access to the Everest Application Server and the Database Server. The HTML page generator preferably may be installed on the same physical server as the Application Server, but may also be installed on another server. The process used by the HTML page generator to create an HTML page in accordance with the invention is described in more detail as follows.

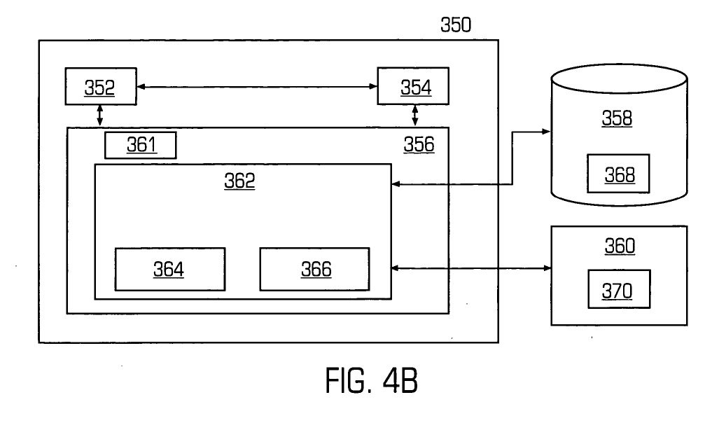

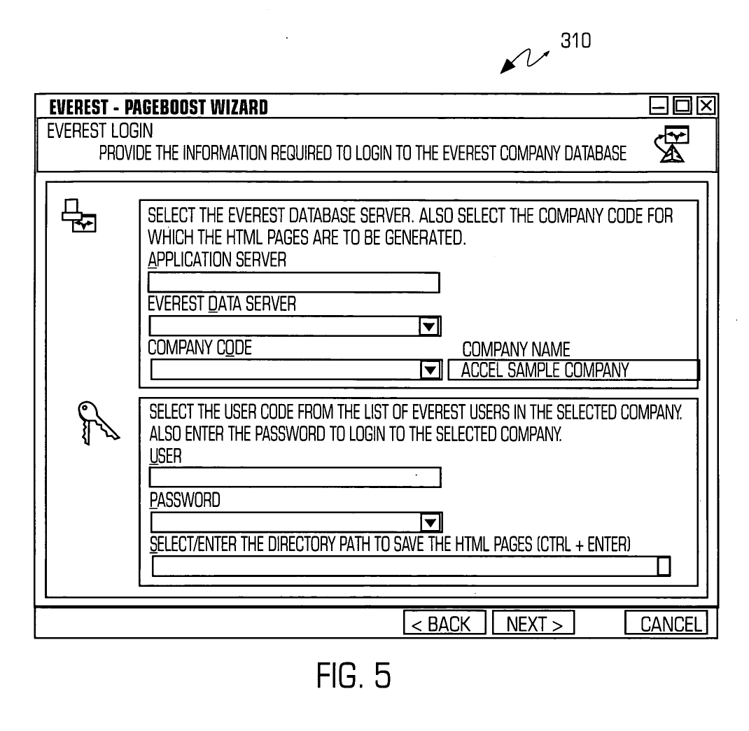

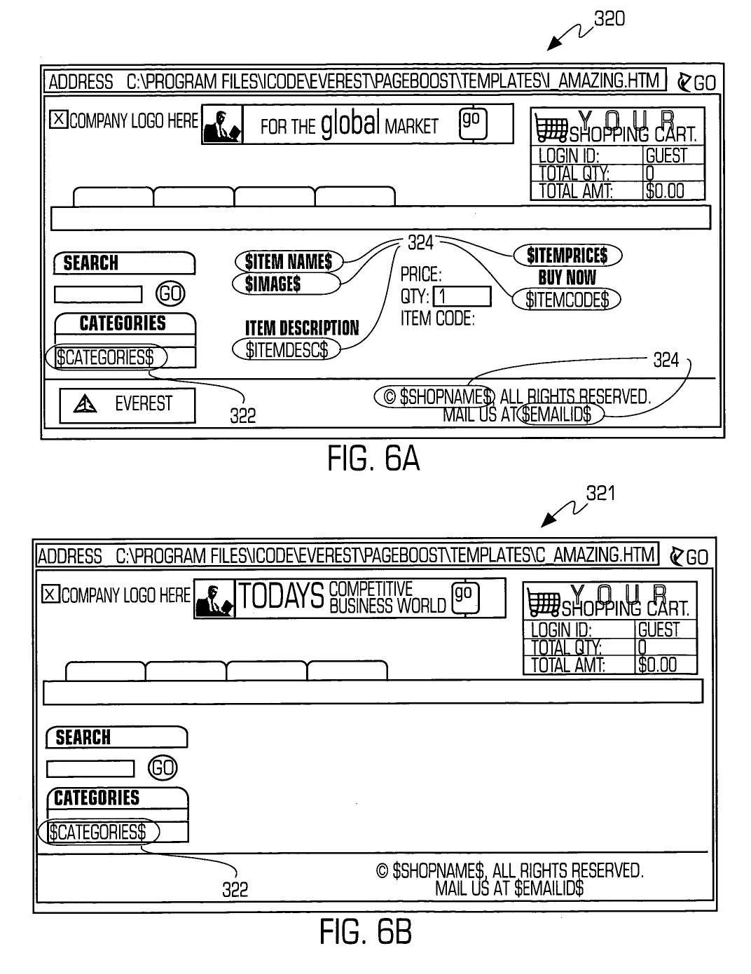

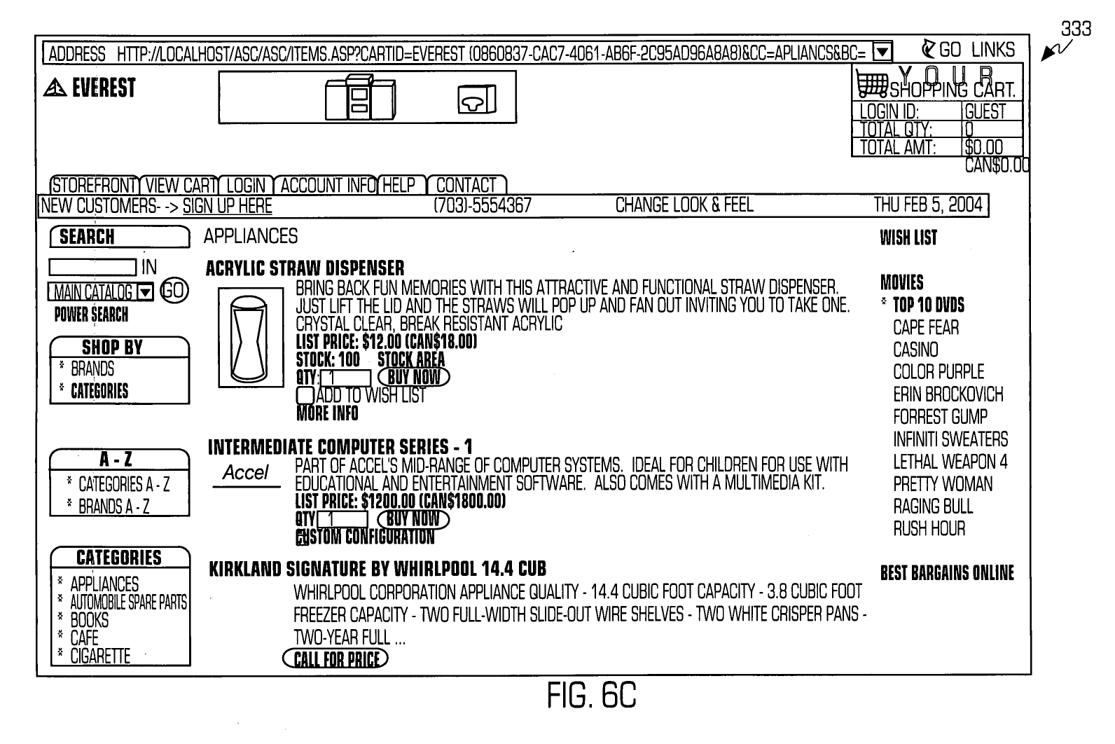

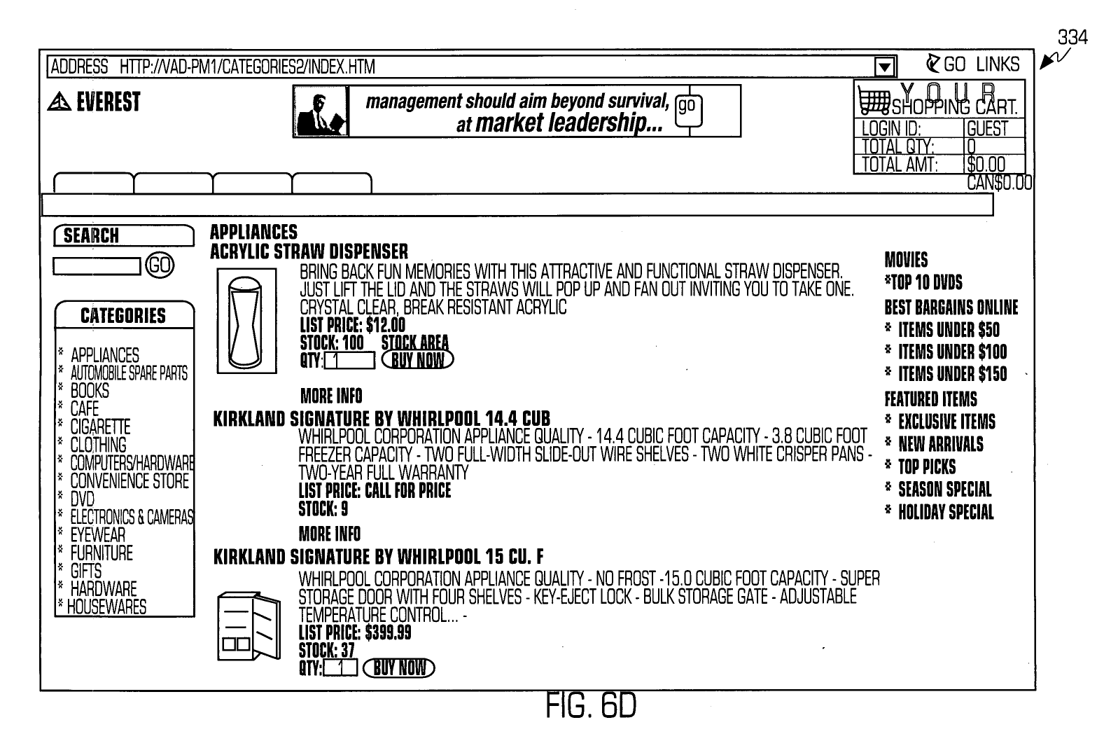

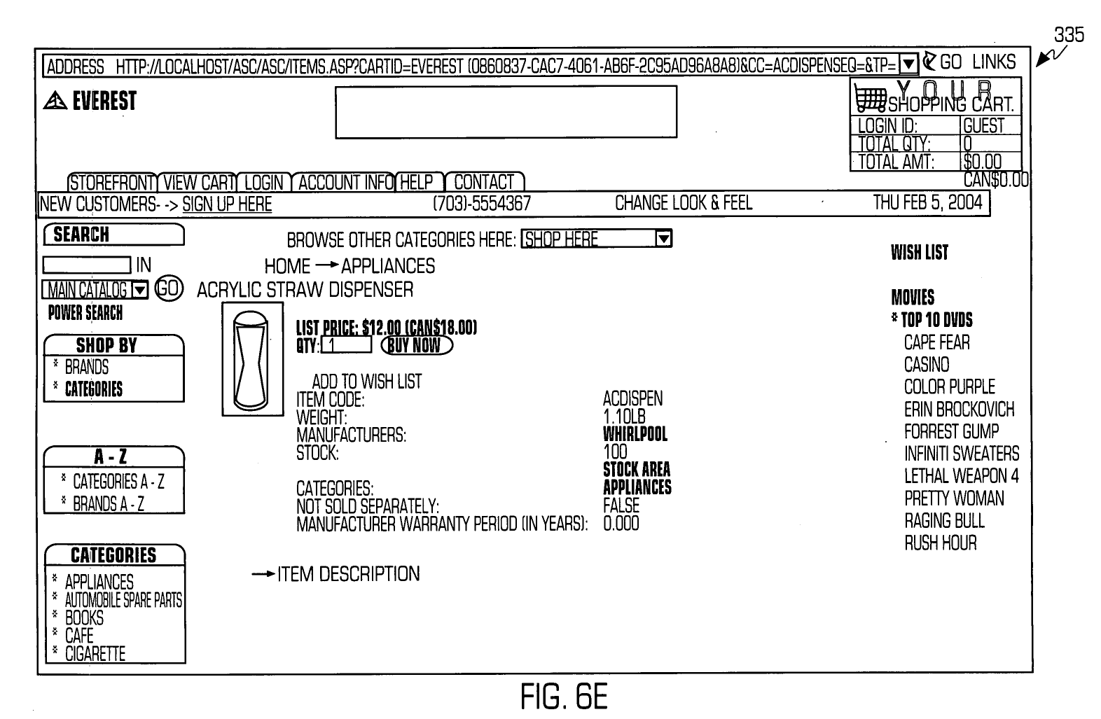

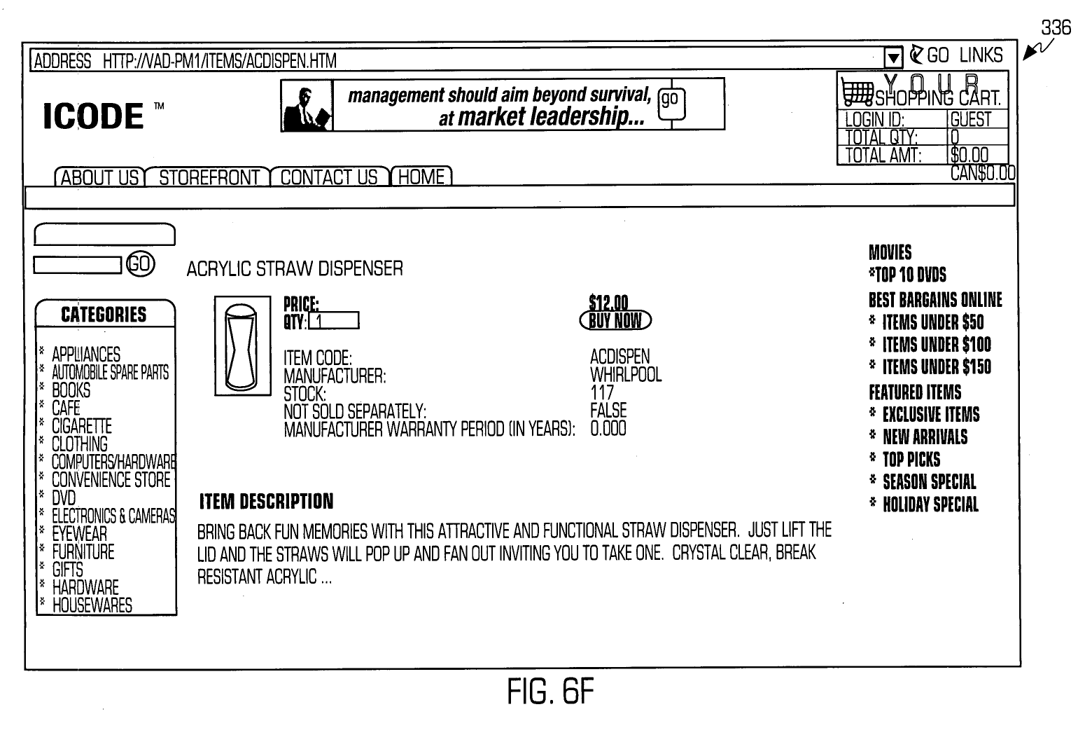

FIG. 4A illustrates a process 300 used by the HTML page generator to create the HTML pages. In step 301, the HTML page generator program interface 310 contains instructions/settings of the User. An example of that interface is shown in FIG. 5 in which the User may specify the Application Server address, Database Server address and company for which the HTML pages are being generated in accordance with the invention. In step 302, the User may use a template 320 for the desired HTML page. The HTML page generator may contain one or more HTML Templates similar to the dynamic Templates in Everest. In accordance with a preferred embodiment of the invention, there may be one template for index/Category Pages or each index/Category Page and one template for item/Item Alias Pages or each item/Item Alias Page. An example of a template 320 for an Item Page (item/Item Alias Page) is shown in FIG. 6A while FIG. 6B illustrates a template 321 for an index/category HTML page.

As shown in FIGS. 6A and 6B, each template 320, 321 is a template for an HTML Web page that includes one or more iTags 322 wherein each iTag is replaced with data from the database when the HTML page is generated by the system. Each template provides the overall structure and look and feel of each HTML page while the actual dynamic data in the page is provided from a database wherein the page is generated based on the iTags. Thus, the system generates static HTML pages (based on the dynamic data in the database) that may then be crawled by typical search engines (unlike dynamic ASP pages that cannot be indexed or searched due to the dynamic data) so that the dynamic pages represented by the generated HTML pages may be properly ranked and indexed by a search engine. For example, the template in FIG. 6A includes an “$ItemName$” iTag, an “$IteniPrice$” iTag, an “$ItemCode$” iTag, an “$ItemDesc$” iTag, a “$Categories$” iTag, an “$Image$” iTag, an “$ShopName$” iTag and an “$emailID$” iTag. In accordance with the invention, each of these different iTags pull different pieces of data from the database to generate an HTML page (with the dynamic data from the database) in accordance with the invention. For example, the database may contain a list of different product categories (in a database table column, for example) that will be placed into a generated HTML page at the location of the “$Categories$” iTag when the HTML page is generated. Similarly, the database may contain a plurality of products to be sold wherein each product includes a product description, a product code, a product price and a product name which are all placed into the generated HTML page based on the location of the iTags shown. The database may also contain an image of the item that is placed at the location of the “$Image$” iTag, a shop name of the e-commerce site owner and an email address for the particular e-commerce site that are placed into the locations of the “$ShopName$” and “$emailID” iTags shown in FIG. 6A. Similarly, for the template shown in FIG. 6B, the categories template 321 has an “$Categories$” iTag that pulls category data from the database to fill in the particular field in the template. In this manner, a template may be created for various different format HTML pages and for HTML pages that contain different dynamic information wherein an HTML page corresponding to the template may be generated based on the data contained in the database.

Thus, in step 303, the Database Server is contacted and product information and other settings are retrieved from the Database Server. In step 304, the iTags 322 in the template are replaced with product information/data from the database. FIGS. 6C and 6D illustrate an example of an ASP Category Page 333 and a corresponding HTML Category Page 334 that are generated for an e-commerce site using the HTML page generator system in accordance with the invention. FIGS. 6E and 6F illustrate an example of an ASP Item Page 335 and a corresponding HTML Item Page 336 that are generated for an e-commerce site using the HTML page generator system in accordance with the invention. FIG. 6C illustrates the ASP Category Page 333 that is generated from the dynamic data in the database. Since the data in the ASP page is dynamic and the ASP page is only generated when the page is sent to the User, the ASP page cannot be crawled in the typical manner. However, as shown in FIG. 6D, the corresponding HTML page 334 is shown that contains the same data as the ASP page, but can be crawled and indexed by search engines since the HTML page is static and the data on the page is also static. Similarly, FIG. 6E illustrates the ASP Item Page 335 (which is dynamic and has dynamic data) and FIG. 6F illustrates the corresponding HTML page 336 that is generated by the system in accordance with the invention and contains static data that is capable of being crawled and indexed. In accordance with the invention, the data and content in the ASP page and the corresponding HTML page is very similar so that the Web crawler/search engine generates an accurate index of an ASP page based on the HTML page.

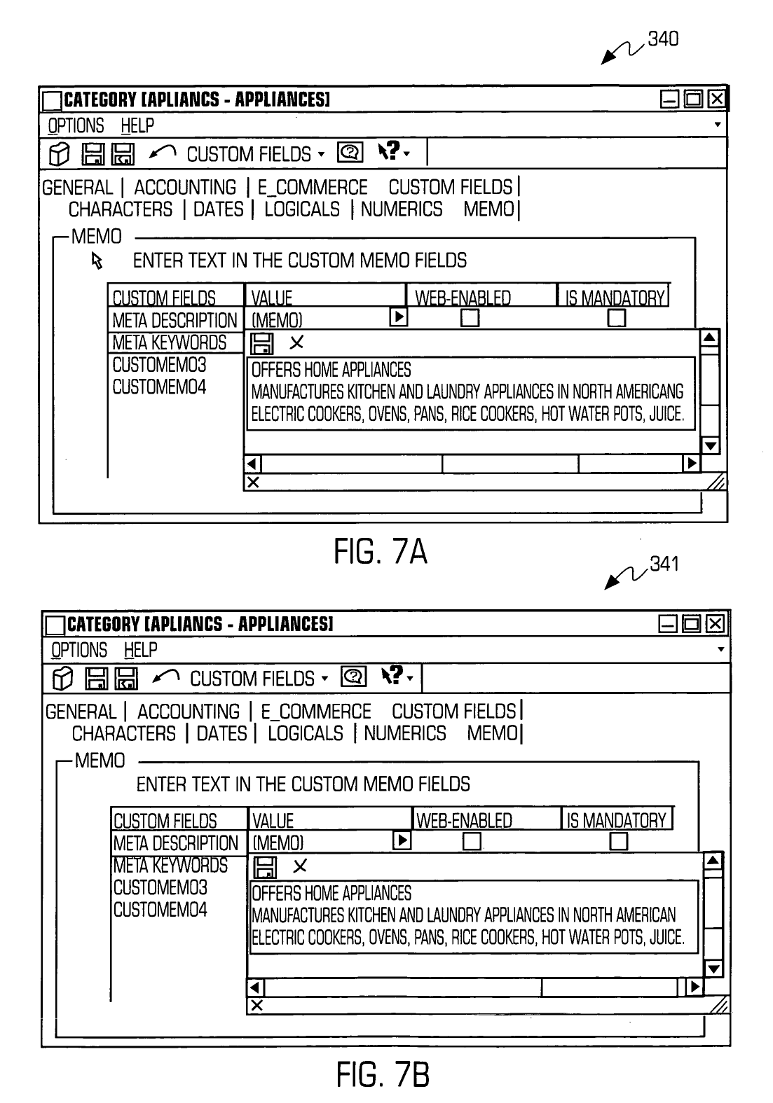

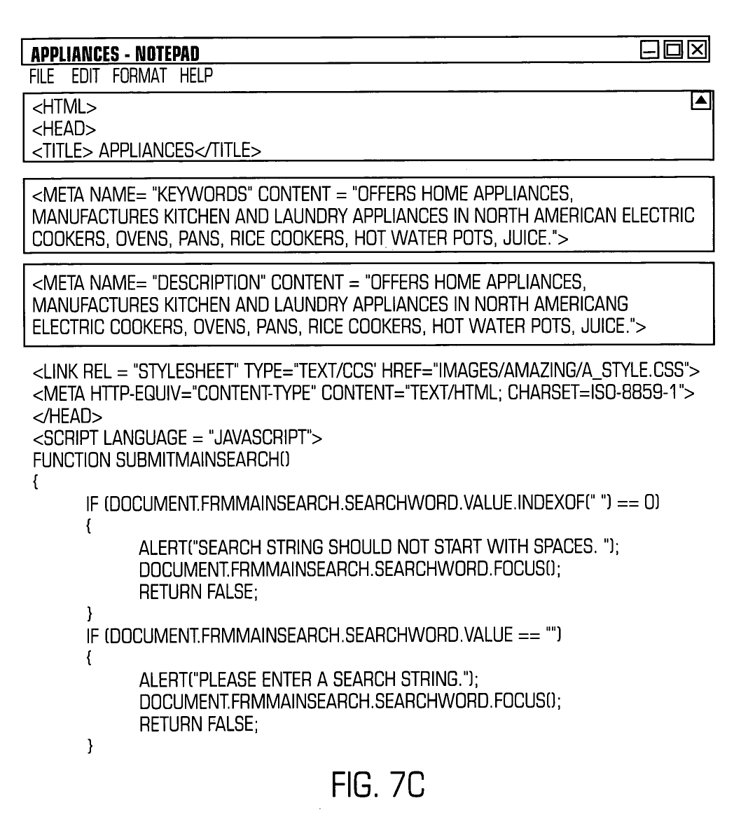

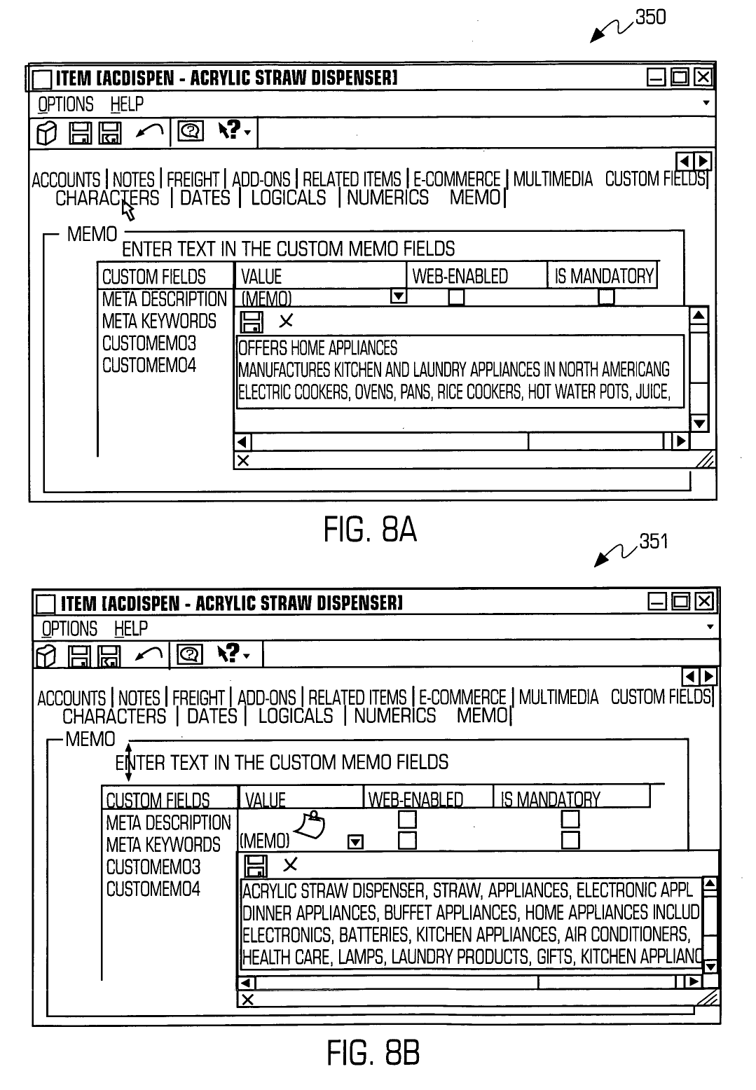

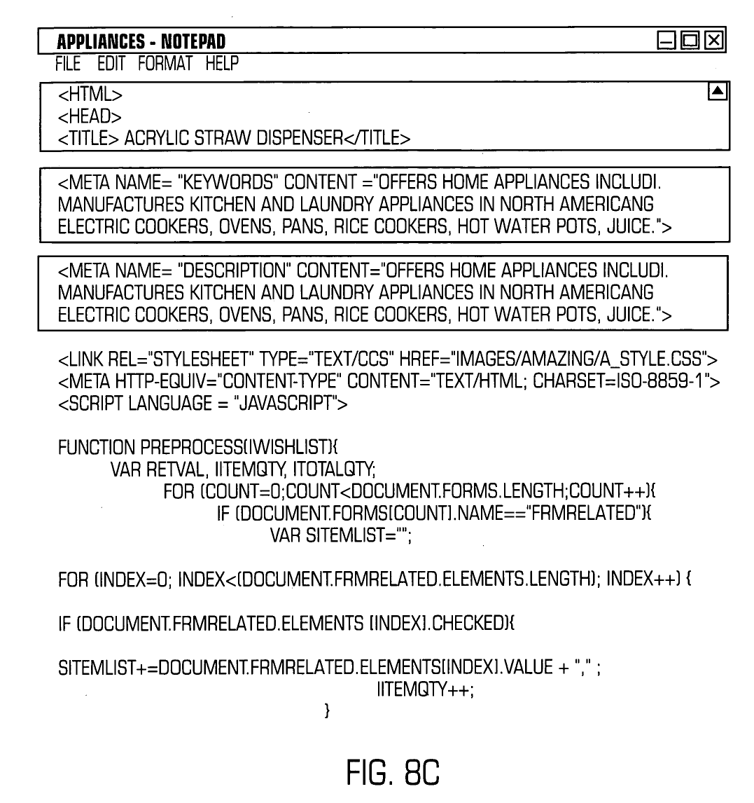

Thus, an HTML page with META tags for keywords and description and with product information is generated for categories/items/item aliases in step 305. The generated HTML pages are shown In FIGS. 6D and 6F above in which the iTags have been replaced with data from the database. FIGS. 7A-C are examples of a first and second Category Page META tag User interfaces and a listing of the source of the META tags, respectively, while FIG. 8A-C are examples of a first and second Item Page META tag User interfaces and a source of the META tags, respectively. In particular, FIGS. 7A and 7B illustrate a first and second category META tag User interface 340, 341 wherein the User may enter data into the database for the META tags for the Category Page. In the example shown in FIGS. 7A and 7B, the META data is the same, although it will typically be different as shown in FIG. 8A-C. FIG. 7C shows the HTML source code for the META tags that permit the HTML pages generated by the system to be searched and indexed by typical crawlers. Similarly, FIGS. 8A and 8B illustrate User interfaces 350, 351 that permit a User to enter the META tag description and keywords (which are different in this example) for a particular item in the database and FIG. 8C shows the HTML source code for the META tags that permit the HTML pages generated by the system to be searched and indexed by typical crawlers. A computer system implementation of the HTML page generator in accordance with the invention is described as follows.

FIG. 4B is a block diagram illustrating an example of a computer implemented HTML page generation system 350 in accordance with the invention. In accordance with the invention, the HTML page generation system may also be implemented as one or more software modules/pieces with a plurality of instructions of code residing on a physical data storage medium, such as a CD-ROM, DVD or other storage medium, wherein the software is installed from the CD-ROM onto a computer system for execution or executed by the computer system directly from the physical data storage medium. Similarly, the HTML page generation system may be implemented as pieces of software embedded onto a hardware device wherein a computer system executes the HTML page generation system using the hardware device. The computer implemented system 350 comprises various well known computer resource components whose function and operation are not described as they are well known, including one or more processors 352, a persistent storage device 354, such as a hard disk drive, optical drive, tape drive, or flash memory, and memory 356, such as DRAM, SRAM or the like, that stores the data and instructions being executed by the computer while the computer is turned on. The computer system 350 may further include other well known components such as various input/output devices and devices that connect the computer system to the Internet and a computer network.

To implement the HTML page generation system in accordance with the invention, the computer implemented system includes a database 358 containing business information and a Web Server 360 that generates HTML pages as is well known. The computer implemented system 350 further includes one or more pieces of software that implement the HTML page generation system such as a well known operating system 361 and an HTML page generation application 362 with a User interface portion 364 and a template storage portion 366. In the example shown, these pieces of software reside in the memory 356 and are being executed by the processor 352 to implement the HTML page generation system. For example, the User interface portion 364 presents the graphical User interface presented to the User to operate the HTML page generation system and the template portion 366 stores the one or more Templates that are used to generate the HTML pages in accordance with the invention. The HTML page generation application 362 contains instructions that implement the other functions of the HTML page generation system, such as the database query and insertion of the data from the database into the HTML page in accordance with the invention. In accordance with the invention, the HTML page generation system may download business data 368 from the database 358 and generate HTML pages 370 that are generated by the well known Web Server 360.

In accordance with another aspect of the invention, an HTML page generating system for use with online product catalogs and shopping carts is provided. The system comprises a set of HTML Templates with iTags, one for index/Category Pages and the other for item/Item Alias Pages, means for contacting and obtaining the product information and other settings from the Database Server, means for replacing the iTags with product information from the database and means for producing the HTML page with META tags for keywords and description and with product information being generated for categories/items/item aliases.

In accordance with another aspect of the invention, a method of generating HTML pages for online product catalogs and shopping carts by integrating seamlessly with the database which can be submitted to search engines is provided. In accordance with yet another aspect of the invention, a method of generating HTML pages for online product catalogs and shopping carts is provided. In the method, a set of HTML Templates with iTags are created in which there is one template for each index/Category Page and one for item/Item Alias Pages. Next, product information and other settings are obtained from the Database Server and the iTags are replaced with the product information so obtained. Next, the HTML page with META tags for keywords and description and with product information for categories/items/item aliases is generated.

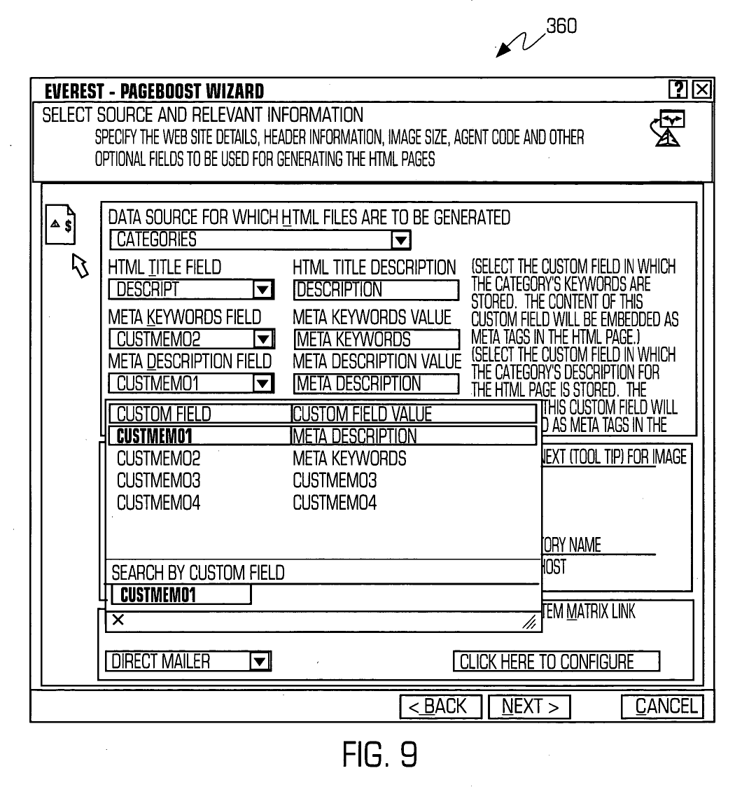

FIG. 9 illustrates a User interface 360 that permits the User of the HTML page generator system to select the META database fields for a particular HTML page to be generated by the system. In particular, the User interface permits the User to select a particular data source from the database, such as Categories, from which to generate the HTML page, the title of the HTML page and where the title is located in the database, the META keywords value and where it is located in the database (placed into the database using the User interfaces shown in FIG. 7A, 7B, 8A and 8B), the META description field and its location in the database and any custom fields in the database and wherein the data for those fields is mapped. In this manner, the User is able to specify the META tag data that is used to generate the HTML pages in accordance with the invention.

While the foregoing has been with reference to a particular embodiment of the invention, changes in this embodiment may be made without departing from the principles and spirit of the invention, the scope of which is defined by the appended claims.

1. A static page generating system for use with a system that generates dynamic active server pages from a database of data, the system comprising:
a database containing data to be inserted into the dynamic active server pages;
a template stored in the database that contains at least one iTag wherein each iTag corresponds to a particular piece of data in a database; and
a software application executing on the system that has a set of instructions to generate a static page based on the template wherein the iTag is replaced with the corresponding data in the database so that the static page has static data, based on the data in the database, that is indexable by a crawler.

2. The static page generation system of claim 1, wherein the static page further comprises an HTML page.

3. The static page generating system of claim 1, wherein the computer software further comprising instructions that replace the iTag in the template with product information from a database.

4. The static page generation system of claim 3, wherein each template further comprises a product name iTag, a product price iTag, a product code iTag and a product description iTag wherein product name, price, code and description data from the database are inserted into the generated HTML page.

5. The static page generating system of claim 1, wherein the template further comprises a template for each index/category HTML page and a template for each item/item alias HTML page.

6. A static page generating system for use with a system that generates dynamic active server pages from a database of data, the system comprising:
a set of templates stored in a database, each template with at least one iTag wherein each iTag corresponds to a particular piece of data in a database, the set of templates further comprising a template for a static category page and a template for a static item page;
means for obtaining data in the dynamic active server pages from a database connected to the static page generation system; and
means for replacing the iTags in the template with the data from the database to produce a static page so that the static page has static data, based on the data in the database, that is indexable by a crawler.

7. The static page generation system of claim 6, wherein the static page further comprises an HTML page.

8. The static page generating system of claim 6, wherein the computer software further comprising instructions that replace the iTag in the template with product information from a database.

9. The static page generation system of claim 8, wherein each template further comprises a product name iTag, a product price iTag, a product code iTag and a product description iTag wherein product name, price, code and description data from the database are inserted into the generated HTML page.

10. The static page generating system of claim 6, wherein the template further comprises a template for each index/category HTML page and a template for each item/item alias HTML page.

11. A method of generating a static page for use with a system that generates dynamic active server pages from a database of data, the method comprising:
storing a set of templates, each template having at least one iTag wherein each iTag corresponds to a particular piece of data in a database, the set of templates further comprising a template for a static category page and a template for a static item page;
obtaining data in the dynamic active server pages from a database connected to the static page generation system; and
replacing the iTags in the template with the data from the database to produce a static page so that the static page has static data, based on the data in the database, that is indexable by a crawler.

12. The static page generation method of claim 11, wherein the static page further comprises an HTML page.

13. The static page generating method of claim 11 further comprising replacing the iTag in the template with product information from a database.

14. The static page generation method of claim 13, wherein each template further comprises a product name iTag, a product price iTag, a product code iTag and a product description iTag wherein product name, price, code and description data from the database are inserted into the generated HTML page.

15. The static page generating method of claim 11, wherein the template further comprises a template for each index/category HTML page and a template for each item/item alias HTML page.

16. A static page generating system for use with a system that generates dynamic active server pages from a database of data, the system comprising:
a page generation computer software application;
one or more templates associated with the HTML page generation application, each template containing at least one iTag wherein each iTag corresponds to a particular piece of data in a database with data that generates dynamic active server pages; and
the static page generation application further comprising a module that replaces the iTag in the template with the corresponding data from the database so that the static page has static data, based on the data in the database, that is indexable by a crawler.

17. The static page generation system of claim 16, wherein the static page further comprises an HTML page.

18. The static page generating system of claim 16, wherein the computer software further comprising instructions that replace the iTag in the template with product information from a database.

19. The static page generation system of claim 18, wherein each template further comprises a product name iTag, a product price iTag, a product code iTag and a product description iTag wherein product name, price, code and description data from the database are inserted into the generated HTML page.

20. The static page generating system of claim 16, wherein the template further comprises a template for each index/category HTML page and a template for each item/item alias HTML page.
